(19) United States
(12) Patent Application Publication
(10) Pub. No.: US 2019/0307150 A1
(43) Pub. Date: Oct. 10, 2019

(54) LIVESTOCK FEED PRODUCTION SYSTEM AND METHOD

(71) Applicant: Avocet IP Limited, Berwick Upon Tweed, Northumberla (GB)

(72) Inventor: James Robert JENNINGS, Yarm, North Yorkshire (GB)

(21) Appl. No.: 16/467,616

(22) PCT Filed: Dec. 4, 2017
(86) PCT No.: PCT/EP2017/025356

§ 371 Date: Jun. 7, 2019

(30) Foreign Application Priority Data
Dec. 8, 2016 (GB) 1620936.3

(51) Int. Cl. A23K 50/10; A23K 10/30

(52) U.S. Cl. CPC A23K 50/10; A01G 31/00; A23K 10/30

(57) ABSTRACT

A livestock feed production apparatus for generating feed for livestock, wherein the livestock feed production arrangement includes an arrangement for supplying seeds. The livestock feed production apparatus includes a hydroponics arrangement for receiving the supplied seeds and for germinating and growing the supplied seeds in a light-excluded environment in one or more trays to generate plant growth material, and a harvesting arrangement for receiving the plant growth material and processing the plant growth material to generate the corresponding livestock feed for livestock. Moreover, the livestock feed production apparatus includes an irrigation arrangement that is operable to expose the supplied seeds to one or more drying steps during growth of the seeds temporally interposed between one or more wet steps during which the seeds are exposed to at least one nutrient solution.

### TECHNICAL FIELD

The present disclosure relates to livestock feed production systems. Moreover, the present disclosure concerns methods of operating the aforementioned systems for producing livestock feed. Moreover, the present disclosure relates to a computer program being executable by a computerized device comprising processing hardware to execute the aforesaid methods.

### BACKGROUND

Conventionally, cattle on farms are grazed on grass in an outdoor environment and are provided with food supplements on a periodic basis, for example during severe winter months when the cattle are settled indoors.

Present farming techniques for rearing cattle are not sufficiently productive to meet future demand for meat products at a cost that the future population are likely to be able to afford, as energy-per-capita (e) falls drastically as a consequence of increasing world population (presently 7 billion people) and depletion of fossil fuel reserves. As a result, there arises a technical problem of how to make agriculture more efficient and productive, especially in respect of meat production, as energy-per-capita (e) falls, and also to be able to satisfy requirements for the supply of Omega-3 oils for enhancing human health.

Livestock is conventionally allowed to graze in pasture and similar terrain, and fed on silage in winter, wherein the silage is generated from harvested plant material, by way of a fermentation process. The silage provides the livestock with sufficient nutrition to survive, it is not particularly exciting for the livestock to eat, as they enjoy fresh plant material with exciting aromas and textures; this is important with regards to animal welfare.

Although intensively farmed animals are known, for example as in the poultry industry, such techniques are not suitable for other types of animals other than poultry. Therefore, there arises a need to provide improved livestock feed production apparatus for supporting advanced highly productive forms of agriculture. Of particular importance is to ensure that cattle receive sufficient roughage for their digestive systems to function in an efficient manner, which is also conducive to good animal welfare.

### SUMMARY

The present disclosure seeks to provide a livestock feed production apparatus for generating feed for livestock. The present invention also seeks to provide a method of operating aforementioned livestock feed production apparatus for generating feed for livestock. Further, the present disclosure seeks to provide a computer implementable program operable to execute the aforesaid methods on the aforesaid system.

According to a first aspect of the present invention, there is provided a livestock feed production apparatus for generating feed for livestock, wherein the livestock feed production arrangement includes:

(i) a seed supply arrangement for supplying seeds;
(ii) a hydroponics arrangement for receiving the supplied seeds and for germinating and growing the supplied seeds in a light-excluded environment in one or more trays to generate plant growth material;
(iii) a harvesting arrangement for receiving the plant growth material and processing the plant growth material to generate the corresponding livestock feed for livestock
(iv) an irrigation arrangement for exposing the supplied seeds to one or more drying steps during growth of the seeds temporally interposed between one or more wet steps during which the seeds are exposed to at least one nutrient solution; and
(v) a data processing arrangement for controlling input of resources into the apparatus by using a mathematical model when growing the supplied seeds, wherein the mathematical model is based upon the measured plant growth characteristics, as a function of physical parameters that influence the measured plant growth characteristics,
wherein the mathematical model is applied in an iterative manner, whilst monitoring a state of growth of the seeds (G(t)) and a state of mould growth of the seeds (M(t)) as a real-time input to the mathematical model.

The present disclosure presents an advantage in that the livestock feed production apparatus and the method of operating the aforesaid system is an efficient production of feedstock feed in a controlled environment.

Optionally, the one or more drying steps employing drying conditions that are a function of an evenness of distribution of the seeds within the one or more hydroponics trays, wherein the apparatus includes a seed distribution arrangement for achieving an even distribution of the seeds along and across the one or more trays.

Optionally, the apparatus employs (in operable) a nitrogen-enriched air to aerate the growing seeds during the one or more drying steps, wherein the nitrogen-enriched air is employed using an environmental parameter control arrangement and wherein the apparatus controls (in operations) a humidity of the one or more trays when employing the nitrogen-enriched air to aerate the growing seeds during the one or more drying steps. Optionally, the physical parameters that influence the measured plant growth includes one or more of:

(vi) a temporal function of a quantity of water supplied W(t) to the seeds in one or more trays of the apparatus;
(vii) a temporal function of a nutrient solution N(t) supplied to the seeds in the one or more trays;
(viii) a temporal function of temperature (T) of the seeds when growing in the apparatus;
(ix) a function of water cycle employed R(t) when supplying water to the seeds in the apparatus;
(x) a temporal function of ozone exposure O(t) applied to the seeds when in the apparatus;
(xi) a temporal function of lighting applied to the growing seeds (L(t)) when in the apparatus; and
(xii) a planting density (D) employed when applying the seeds to the one or more trays.

Optionally, the apparatus (in operations):
blends supplementary materials into the corresponding livestock feed, wherein the supplementary materials include at least one of: hay, wild flower supplements, aromatic supplements, vitamin supplements, growth supplements, antibiotics;
employs a gaseous fumigation arrangement for gaseously fumigating the supplied seeds prior to germination to reduce an occurrence of mould growth therein during germination and growing of the seeds to form roots and shoots;
employs the gaseous fumigation arrangement to utilize ozone gas for fumigating the supplied grain to reduce growth of mould in the plant growth material; and/or
arranges for the one or more hydroponics trays to be disposed in one or more vertical stacks, wherein planes of the one or more hydroponics trays for receiving the seeds are substantially mutually parallel.

Optionally, the apparatus is operable to provide the ozone gas for fumigation in a concentration of 20 to 40 p.p.m for a period of 5 minutes to 1 hour. Alternatively, the apparatus is operable to provide the ozone gas for fumigation temporally and periodically for fumigating the supplied grain in response to detection of mould formation upon the supplied seeds, their roots and/or their shoots.

Optionally, one or more hydroponics trays have a length-to-width ratio of 3:1 to 10:1. Or one or more trays are provided with an actuation arrangement for selectively flexing regions of the one or more hydroponics trays for sweeping ponding of nutrient solution occurring therein along a length of the one or more hydroponics trays.

Optionally, one or more trays are disposed in operation on a carousel for at least one of: the application of seeds to one or more trays for growing the plant growth material on one or more trays, harvesting the plant growth material from one or more trays.

Optionally, the livestock feed production apparatus includes an arrangement for receiving waste from the animals, and for anaerobically digesting the waste to generate methane gas.

Optionally, the apparatus is operable to employ off-grid with electricity supplied from at least one of: methane fuel, solar cells, wind turbines, naturally-occurring water flow.

According to a second aspect, there is provided a method of operating a livestock feed production apparatus for generating feed for livestock, wherein the livestock feed production arrangement includes:

(i) arranging a seed supply arrangement for supplying seeds;
(ii) arranging a hydroponics arrangement for receiving the supplied seeds and for germinating and growing the supplied seeds in a light-excluded environment in one or more trays to generate plant growth material;
(iii) a harvesting arrangement for receiving the plant growth material and processing the plant growth material to generate the corresponding livestock feed for livestock;
(iv) arranging an irrigation arrangement for exposing the supplied seeds to one or more drying steps during growth of the seeds temporally interposed between one or more wet steps during which the seeds are exposed to at least one nutrient solution; and
(v) arranging a data processing arrangement for controlling input of resources into the apparatus by using a mathematical model when growing the supplied seeds, wherein the mathematical model is based upon the measured plant growth characteristics, as a function of physical parameters that influence the measured plant growth characteristics,

wherein the mathematical model is applied in an iterative manner, whilst monitoring a state of growth of the seeds (G(t)) and a state of mould growth of the seeds (M(t)) as a real-time input to the mathematical model.

Optionally, the one or more drying steps employing drying conditions that are a function of an evenness of distribution of the seeds within the one or more hydroponics trays, wherein the method includes a seed distribution arrangement for achieving an even distribution of the seeds along and across the one or more trays.

Optionally, the method employs a nitrogen-enriched air to aerate the growing seeds during the one or more drying steps wherein the nitrogen-enriched air is employed using an environmental parameter control arrangement, wherein the method controls a humidity of the one or more trays when employing the nitrogen-enriched air to aerate the growing seeds during the one or more drying steps.

Optionally, the physical parameters that influence the measured plant growth includes one or more of:

(vi) a temporal function of a quantity of water supplied W(t) to the seeds in one or more hydroponics trays;
(vii) a temporal function of a nutrient solution N(t) supplied to the seeds in the one or more hydroponics trays;
(viii) a temporal function of temperature (T) of the seeds when growing in the livestock feed production apparatus;
(ix) a function of water cycle employed R(t) when supplying water to the seeds in the livestock feed production apparatus;
(x) a temporal function of ozone exposure O(t) applied to the seeds when in the livestock feed production apparatus;
(xi) a temporal function of lighting applied to the growing seeds (L(t)) when in the livestock feed production apparatus; and
(xii) a planting density (D) employed when applying the seeds to the one or more trays.

Optionally, the method (in operation):
blends supplementary materials into the corresponding livestock feed, wherein the supplementary materials include at least one of: hay, wild flower supplements, aromatic supplements, vitamin supplements, growth supplements, antibiotics; employs a gaseous fumigation arrangement for gaseously fumigating the supplied seeds prior to germination to reduce an occurrence of mould growth therein during germination and growing of the seeds to form roots and shoots;
employs the gaseous fumigation arrangement to utilize ozone gas for fumigating the supplied grain to reduce growth of mould in the plant growth material; and/or
arranges for the one or more hydroponics trays to be disposed in one or more vertical stacks, wherein planes of the one or more hydroponics trays for receiving the seeds are substantially mutually parallel.

Optionally, the method (in operations) provides the ozone gas for fumigation in a concentration in a range of 20 to 40 p.p.m. for a period in a range of 5 minutes to 1 hours. Alternatively, the method is operable to provide the ozone gas for fumigation temporally periodically for fumigating the supplied grain in response to detection of mould formation upon the supplied seeds, their roots and/or their shoots.

Optionally, the one of more hydroponics trays have a length-to-width ratio in a range of 3:1 to 10:1. More optionally, the one or more trays are provided with an actuation arrangement for selectively flexing regions of the one or more hydroponics trays for sweeping ponding of nutrient solution occurring therein along a length of the one or more hydroponics trays.

Optionally, the one or more trays are disposed in operation on a carousel for at least one of: applying seeds to the one or more trays for growing the plant growth material on the one or more trays, harvesting the plant growth material from the one or more trays.

Optionally, the method includes an arrangement for receiving waste from the animals, and for anaerobically digesting the waste to generate methane gas.

Optionally, the method is operable to employ off-grid with electricity supplied from at least one of: methane fuel, solar cells, wind turbines, naturally-occurring water flow.

Optionally, there is provided a computer program product comprising a non-transitory computer-readable storage medium having computer-readable instructions stored thereon, the computer-readable instructions being executable by a computerized device comprising processing hardware to execute aforementioned methods.

It will be appreciated that features of the invention are suitable for being combined in various combinations without departing from the scope of the invention as defined by the appended claims.

### DESCRIPTION OF THE DIAGRAMS

Embodiments of the present disclosure will now be described, by way of example only, with reference to the following diagrams wherein:

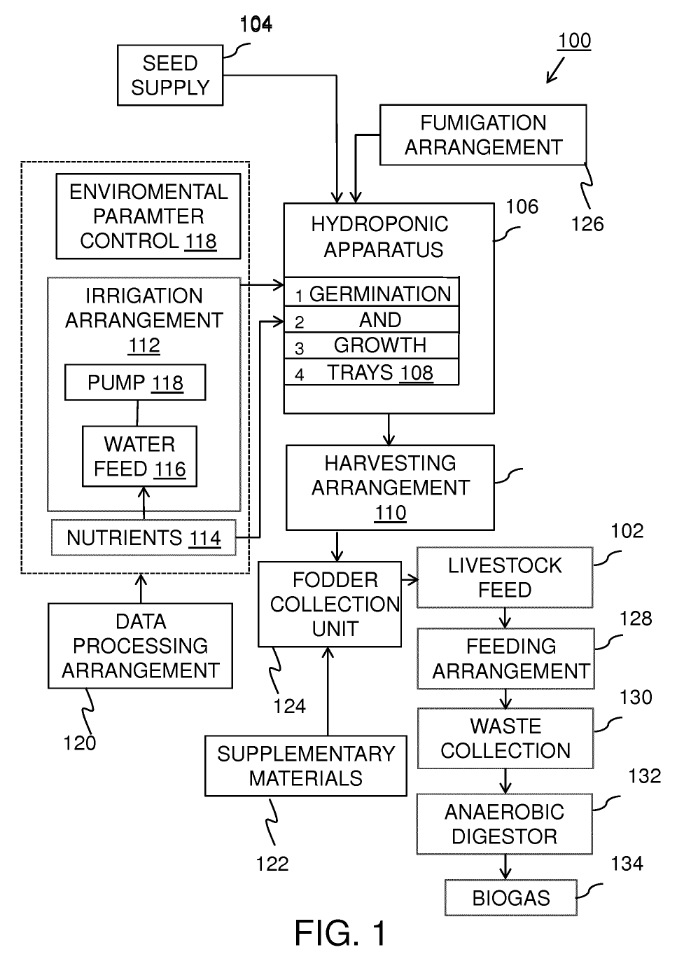

FIG. 1 is a block diagram of a livestock feed production apparatus for generating feed for livestock, in accordance with an embodiment of the present disclosure; and

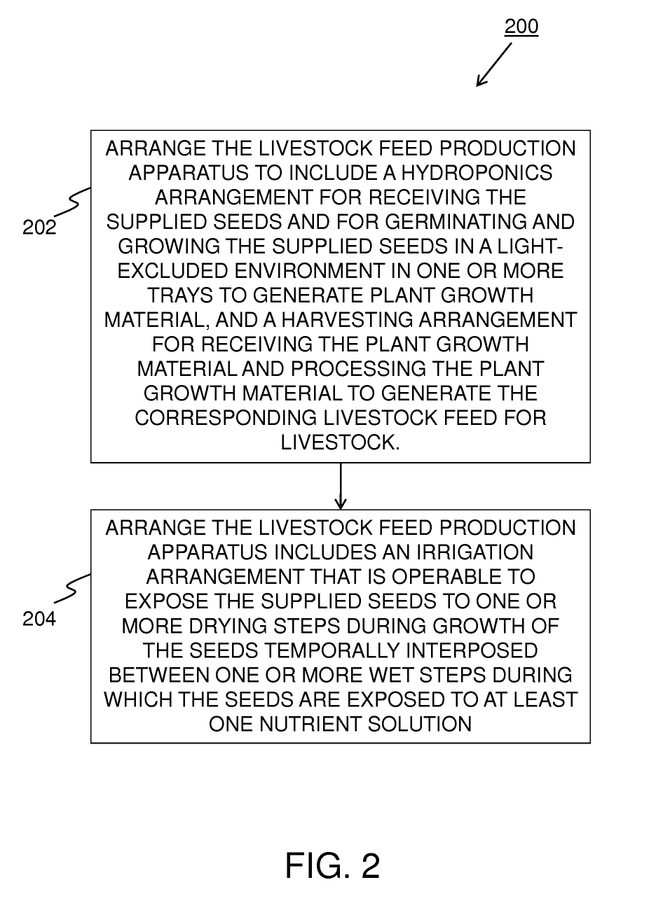

FIG. 2 is a flow chart of method of operating a livestock feed production apparatus of FIG. 1 for generating feed for livestock, in accordance with an embodiment of the present disclosure.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

In overview, embodiments of the present disclosure are concerned with highly efficient apparatus for producing feed for livestock in a manner that is more efficient than conventional known farming techniques, and provides highly fibrous livestock feed that is both more enjoyable and nutritious for livestock to consume.

Moreover, embodiments of the present disclosure provide a method that is more conducive to efficient collection of waste products from livestock and processing such waste to provide useful bi-products, for example methane gas generated from anaerobic digestion processes.

FIG. 1 is a block diagram of a livestock feed production apparatus 100 for generating feed 102 for livestock, in accordance with an embodiment of the present disclosure. As shown, the livestock feed production apparatus 100 includes a seed supply arrangement 104 for supplying seeds and a hydroponics arrangement 106 for receiving the supplied seeds from the seed supply unit 104 and for germinating and growing the supplied seeds in a light-excluded environment in one or more trays 108 to generate plant growth material. The livestock feed production apparatus 100 also includes a harvesting arrangement 110 for receiving the plant growth material and processing the plant growth material to generate the corresponding livestock feed 102 for livestock. Moreover, the livestock feed production apparatus 100 includes an irrigation arrangement 112 operable for exposing the supplied seeds to one or more drying steps during growth of the seeds temporally interposed between one or more wet steps during which the seeds are exposed to at least one nutrient solution 114. The irrigation arrangement 112 may include a water feed arrangement 116 and a pump 118 for exposing the supplied seeds to one or more drying steps during growth of the seeds temporally interposed between one or more wet steps.

In an embodiment, the seed supply unit 104 may be operable for pre-treatment of the seeds before supplying the seeds to the hydroponics apparatus 106. For example, the pre-treatment of seeds may include but not limited to removal of loose chaff and remnants of husks and broken seeds.

In an embodiment, the seeds supplied from the seed supply unit 104 to the hydroponics apparatus 106 may be one of Spring Barley, although other types of grain such as alfalfa, maize, oats can also be used for fodder production.

The hydroponics apparatus 106 of the livestock feed production apparatus 100 has an option of a set-up having different arrangements for controlling different growth parameters. The hydroponics apparatus 106 includes one or more trays 108 for receiving the seeds and growing the seeds for producing the plant growth materials.

In an embodiment, the one or more drying steps employing drying conditions may be a function of an evenness of distribution of the seeds within the one or more hydroponics trays 108.

In another embodiment, the one or more drying steps employing drying conditions that may a function of water percolation along the one or more trays 102 when the at least one nutrient solution 114 may be applied thereto.

In another embodiment, the one or more drying steps employing drying conditions that may a function of a flow regime of the at least one nutrient solution 114 along the one or more trays 108.

In an embodiment, the livestock feed production apparatus 100 may include a seed distribution arrangement for achieving an even distribution of the seeds along and across the one or more trays 108. For example, the seed distribution arrangement may arrange an amount of the seeds supplied from the seed supply unit 104 to an area of the growth and germination tray 108 of the hydroponics arrangement 106.

In an embodiment, the livestock feed production apparatus 100 may be operable to employ a nitrogen-enriched air to aerate the growing seeds on the one or more trays 108 of the hydroponics arrangement 106 during the one or more drying steps.

In another embodiment, the livestock feed production apparatus 100 may include an environmental parameter control arrangement 118 for controlling various environment parameters, such as temperature, humidity, aeration, and so forth. For example, environmental parameter control arrangement 118 may be operable to control a humidity of the one or more trays 108 when employing the nitrogen-enriched air to aerate the growing seeds during the one or more drying steps.

In an embodiment, the livestock feed production apparatus 100 may be operable to use a mathematical based upon the measured plant growth characteristics, as a function of physical parameters that influence the measured plant growth characteristics. In present embodiment, the livestock feed production apparatus 100 may be operable to apply the mathematic model in a data processing arrangement 120 for controlling input of resources into the apparatus 106 when growing seeds in the trays 108.

In an exemplary embodiment, the livestock feed production apparatus is operable to use a mathematical model based upon the measured plant growth characteristics generated. The plant growth characteristics may include but are not limited to; a temporal function of a quantity of water supplied W(t) to the seeds in one or more trays 108 of the hydroponics apparatus 106, a temporal function of a nutrient solution N(t) supplied to the seeds in the one or more trays 108, a function of water cycle employed R(t) when supplying water to the seeds in the hydroponics apparatus 106, a temporal function of ozone exposure O(t) applied to the seeds when in the hydroponics apparatus 106, a temporal function of lighting applied to the growing seeds (L(t)) when in the hydroponics apparatus 106 and a planting density (D) employed when applying the seeds to the one or more trays 108 of the hydroponics apparatus 106.

In an exemplary embodiment, the temporal function of the quantity of water supplied W(t) may be quantity of water required by the seeds in the hydroponics apparatus 106 at a time for generating the plant growth material. The temporal function of the nutrient solution N(t) supplied to the seeds in the one or more trays 108 may be quantity of nutrient solution 114 required for growing the plant growth material by the seeds at a time. For example, the temporal function of the nutrient solution N(t) may be concentrations of individual nutrient salts present in the nutrient solution (such as nitrates, phosphates, chlorides, sulphate, Sodium, Potassium, Manganese, Magnesium, Copper, Iron, and so forth). The temporal function of temperature (T) may be the temperature of seeds in the hydroponics apparatus 106 for generating the plant growth material. The function of water cycle employed R(t) may be a periodically water supply 116 to the seeds in the hydroponics apparatus 106 (such as length of inter-watering dry period, length of watering wet period, and so forth). The temporal function of ozone exposure O(t) may be the amount of ozone supplied for a time duration for fumigating the seeds during growth in the hydroponics apparatus 106. The temporal function of lighting applied to the growing seeds (L(t)) may a duration of light exposure to the growing seeds in the hydroponics apparatus. For example, the duration of light exposure to the growing seeds may be the minimal exposure to the light received by the seeds in a growing cycle of 4 to 8 days. Further the planting density (D) may be an amount of seeds supplied in an area of the one or more trays of the hydroponics apparatus 106 for generating the plant growth material.

In an example, the measured plant growth characteristics may include temporal growth of plant material G(t) and mould M(t). In such example, the mathematical model F may be a temporal function of measurable components such as the water supplied W(t), the nutrient solution N(t), the temperature T(t) of the seeds, the water cycle employed R(t), the ozone exposure O(t), the lighting applied to the growing seeds L(t), and the planting density (D) of seeds on the one or more trays 108. In another example, the mathematical model F may be used to determine the growth of plant material G(t) and mould M(t) after a specific period of time. In such example, a relation may be formed between the aforementioned measurable components to determine the growth of plant material G(t) and mould M(t), such as

[G(t+Δt),M(t+Δt)]=F[D,W(t),N(t),T(t),R(t),O(t),L(t),G(t),M(t)]

In the aforementioned relation Δt may be the representation of change in time. Further, in such example, a limited set of experimental results can be extrapolated by linear or polynomial interpolation to provide intermediate states of the mathematical model.

In an embodiment, the mathematical model may be applied in an iterative manner while monitoring a state of mould growth of the seeds (M(t)) as a real-time input to the mathematical model. For example, the mould growth of the seeds (M(t)) may be an amount of Aspergillus growth on seeds during generation of the plant growth material in the hydroponics apparatus.

The data processing arrangement 120 of the apparatus 100 is operable to implement the mathematical model for controlling input of resources into the hydroponics apparatus 106 when growing the seeds therein. For example, the data processing arrangement 120 may be operable to control the water feed unit 116 and the nutrient feed 118.

In an embodiment, the data processing arrangement 120 may be a processing hardware, software, firmware or a combination of these, suitable for implementing the mathematical model. In an embodiment, the data processing arrangement may include general electronic components suitable for controlling input of resources into the hydroponics apparatus. The general electronic components may comprise an input means, an output means, a processor, a memory, a network adapter and so forth. For example, the memory may be operable to store the mathematical model. In such example, the processor may be operable to execute mathematical model.

In an embodiment, the apparatus 100 may be operable for measuring plant growth characteristics of seeds and the data processing arrangement 114 may be operable for controlling input of resources into the hydroponics apparatus 106 when growing the seeds therein.

In another embodiment, the livestock feed production apparatus 100 may be operable of blending supplementary materials 122 into the corresponding livestock feed 102 for increasing the roughness of the fodder, resulting in the fibrous livestock feed 102. The supplementary materials may be blended in a temporally varying manner with the plant growth material received from the harvesting arrangement of the hydroponics apparatus. In present embodiment, the livestock feed production apparatus 100 may include a fodder collection unit 124 for receiving the plant growth material from the harvesting arrangement 110 and blending the received plant growth material with the supplementary materials 122 to produce the corresponding livestock feed 102.

In an embodiment, the supplementary materials 122 may include one of hay, wild flower supplements, aromatic supplements, vitamin supplements, growth supplements, antibiotics, and so forth. For example, the blending maybe performed in a temporally varying manner, and the supplementary materials 122 may include at least one of spring barley, wheat, rye, oats, barley, buckwheat, quinoa, sorghum, fonio, triticale, millet, rice, maize, and so forth.

In an embodiment, the livestock feed production apparatus 100 may include a gaseous fumigation arrangement 126 for gaseously fumigating the seeds supplied from the seed supply 104 prior to germination to reduce an occurrence of mould growth therein during germination and growing of the seeds to form roots and shoots. In present embodiment, the fumigation arrangement 126 may use ozone gas for fumigating the supplied grain to reduce growth of mould in the plant growth material. The ozone gas may be used temporally periodically in combination with sulphur dioxide and/or chlorine gas for fumigating the supplied seeds in response to detection of mould formation upon the supplied seeds, its roots and/or shoots.

In an exemplary embodiment, the data processing arrangement 120 may be operable to control the fumigation arrangement 126 of the apparatus 100 for producing livestock feed. In the present embodiment, the data processing arrangement 120 may be operable to regulate the ozone concentration and the duration of exposure for removing moulds from the seeds received from the seed supply 104. In another exemplary embodiment, the data processing arrangement 120 may be operable to regulate the ozone concentration and the duration of exposure from the roots and shoots of the seeds growing in the trays 108 of hydroponics apparatus 106.

In an embodiment, the livestock feed production apparatus 100 may be operable to reduce formation of Aspergillus on the supplied seeds by fumigating the one or more trays 108 of the hydroponics apparatus 106 by ozone gas. For example, the one or more trays 106 may be exposed to the ozone gas in periodic intervals. The ozone gas concentration may be in range of 20 p.p.m. to 40 p.p.m. The ozone exposure may be implemented for a duration of 5 minutes to 60 minutes (1 hour).

In another embodiment, the livestock feed production apparatus 100 may be operable to generate the ozone from a discharge process, for example from a corona discharge process, ultraviolet light exposure processor similar. The ozone is preferably directed to roots of the germinated grain in the trays, where possible. The grain is spread evenly around the trays 108 to avoid bunching of distribution of the grain that could cause potential occurrence of Aspergillus or similar mould growth.

In another embodiment, the livestock feed production apparatus 100 may be operable to reduce the formation of Aspergillus on the roots of the plant growth material by exposing to the ozone. For example, at periodic intervals the trays 108 may be exposed to ozone gas (via gaseous fumigation). Optionally, the grains received from seeds supplying arrangement 104 may be treated only once with ozone immediately before germination, but not later during its growing phase. Optionally, ozone treatment may be applied in an event, during the growing phase, that Aspergillus is detected. The ozone gas concentration is beneficially from 0.1 p.p.m. to 200 p.p.m., for example from 0.1 p.p.m. to 100 p.p.m., but more preferably from 10 p.p.m. to 40 p.p.m., sustained for a period of 30 minutes.

Optionally in an embodiment, the livestock feed production apparatus 100 is operable to employ other in combination with ozone, for example Sulphur Dioxide, Nitrous Oxides, to hinder mould growth, with periodic application as aforementioned. Alternatively, the gaseous treatment for Aspergillus is supplied continuously. Alternatively, the gaseous treatment for Aspergillus may be selectively applied only when a trace of Aspergillus is first detected. The trays 108 may be treated with ozone and/or bleach to kill any residual Aspergillus or similar mould between growth cycles of the seeds.

In an embodiment, the livestock feed production apparatus 100 may be operable for arranging the one or more trays 108 of the hydroponics apparatus 106 in a length-to-width ratio in a range of 3:1 to 10:1. For example, the one or more trays 108 may be 30 cm to 1 meter wide. More specifically, the one or more trays 108 may be 60 cm to 80 cm wide. The trays are optionally fabricated from a plastics material. A temperature of the trays may occur in a range of 17° C. to 23° C., more optionally in a range of 20° C. to 22° C.

In another embodiment, the livestock feed production apparatus 100 is operable to arrange the trays 108 of the hydroponics apparatus 106 may be provided with an actuation arrangement for selectively flexing regions of the one or more trays 108 of the hydroponics apparatus 106 for sweeping ponding of nutrient solution 114 occurring therein along a length of the one or more trays 108 of the hydroponics apparatus 106.

In another embodiment, the livestock feed production apparatus 100 includes arranging the trays 108 a vertically rotating carousel and may be pivotable along one of their elongate edges to enable rapid automated emptying of the trays 108 into a collection holder, wherein the germinated seeds may be pulverized as aforementioned to provide livestock feed 102. In present embodiment, the pulverization may only partial so as to provide the livestock feed 102 with interesting texture to munch (for example, to provide for roughage for their digestive system).

In another embodiment, the livestock feed production apparatus 100 may include arranging the trays 108 of the hydroponic apparatus 106 in a vertical manner on the actuation arrangement for preventing ponding along the trays 108. For example, actuation arrangement may be activated in a sequence along a length of the trays 108 to sweep any ponding along the trays. The actuators may be electromagnetic actuators that are actuated under computer control, although hydraulic actuators can alternatively be employed.

In an embodiment, the livestock feed production apparatus 100 may include arranging the trays 108 of the hydroponics apparatus 106 in one or more vertical stacks, wherein planes of the one or more trays 108 for receiving the seeds from the seeds supply unit 104 may be substantially mutually parallel.

In an embodiment, the livestock feed production apparatus 100 may include a feeding arrangement 128 for supplying the livestock feed 102 to animals and an arrangement for receiving waste 130 from the animals.

In another embodiment, the livestock feed production apparatus 100 may include an anaerobic digester 132 for anaerobically digesting the waste to generate biogas 134. In an exemplary embodiment, the biogas 134 may be methane.

In another embodiment, the apparatus 100 may be operate off-grid with electricity supplied from at least one of: methane fuel, solar cells, wind turbines, naturally-occurring water flow. For example, the naturally-occurring water flow may include hydroelectric (stream, river), tidal, wave, and so forth.

In another embodiment, the apparatus 100 may be operable to utilize renewable energy for cooling and/or of the hydroponics apparatus 106, for controlling the environment parameter control arrangement 118 and the data processing arrangement 120.

In an exemplary embodiment, the one or more trays 108 may comprise of at least one sensor to measure the environmental control parameters, such as temperature, humidity, lighting and so forth. In an example, the trays 108 may comprise of optical sensors. In such example, the optical sensor may strobe so that the seeds receive a minimal exposure to light during their growing process, such as 4 to 8 days.

In an exemplary embodiment, the at least one sensor may be operable to detect a spatial extent of the mould with great ease and accuracy. For example, the nutrient solution 114 may be provided with a polypeptide tracer with linked fluorescence arrangement that preferentially binds with the mould, and is susceptible to fluorescing when exposed to ultraviolet interrogation and thereby enabling the one or more optical sensors to detect a spatial extent. Further, in such example, polypeptide tracer can be removed via a washing cycle when the grown seeds are harvested, to avoid the tracer being incorporated into the livestock feed 102. Additionally, the polypeptide tracer may be broken down harmlessly in the digestive systems of the livestock.

In an exemplary embodiment, the one or more trays 108 may be provided with optically transparent windows that enable the roots of the seeds to be inspected directly for mould growth, for example Aspergillus growth.

In an exemplary embodiment, the one or more trays 108 may be selectively provided with the polypeptide tracer. Additionally, the polypeptide tracer may be operable to be used as a control sensing group in contradistinction to mutually similar trays that may be grown under identical conditions but without the polypeptide tracer.

FIG. 2 is a flow chart of method 200 of operating a livestock feed production apparatus (such as the apparatus 100) for generating feed for livestock (such as the feed for livestock 102), in accordance with an embodiment of the present disclosure. At step 202 the flow chart 200 initiates. At step 202 the livestock feed production apparatus is arranged to include a hydroponics arrangement (such as the hydroponics arrangement 106) for receiving the supplied seeds and for germinating and growing the supplied seeds in a light-excluded environment in one or more trays (such as the trays 108) to generate plant growth material. Further, at step 202 a harvesting arrangement (such as harvesting arrangement 110) is arranged that is operable for receiving the plant growth material and processing the plant growth material to generate the corresponding livestock feed for livestock. At step 204, the livestock feed production apparatus includes an irrigation arrangement (such as the irrigation arrangement 112) that may be operable to expose the supplied seeds to one or more drying steps during growth of the seeds temporally interposed between one or more wet steps during which the seeds are exposed to at least one nutrient solution.

In an embodiment, the method 200 may be operable to employ one or more drying steps employing drying conditions that are a function of at least one of, an evenness of distribution of the seeds within the one or more hydroponics trays, water percolation along the one or more trays when the at least one nutrient solution is applied thereto, and a flow regime of the at least one nutrient solution (such as the nutrient solution 120) along the one or more trays.

In an embodiment, the method 200 may be operable to include a seed distribution arrangement for achieving an even distribution of the seeds along and across the one or more trays. In another embodiment, the method 200 may be operable to a nitrogen-enriched air to aerate the growing seeds during the one or more drying steps. Further, the method 200 is operable to control a humidity of the one or more trays when employing the nitrogen-enriched air to aerate the growing seeds during the one or more drying steps.

In an embodiment, the method 200 may be operable to use a mathematical based upon the measured plant growth characteristics, as a function of physical parameters that influence the measured plant growth characteristics, and to apply the mathematic model in a data processing arrangement for controlling input of resources into the livestock feed production apparatus when growing seeds therein. More optionally, the physical parameters that influence the measured plant growth includes one or more of a temporal function of a quantity of water supplied W(t) to the seeds in one or more hydroponics trays, a temporal function of a nutrient solution N(t) supplied to the seeds in the one or more hydroponics trays, a temporal function of temperature (T) of the seeds when growing in the livestock feed production apparatus, a function of water cycle employed R(t) when supplying water to the seeds in the livestock feed production apparatus, a temporal function of ozone exposure O(t) applied to the seeds when in the livestock feed production apparatus, a temporal function of lighting applied to the growing seeds (L(t)) when in the livestock feed production apparatus, and a planting density (D) employed when applying the seeds to the one or more trays.

In another embodiment, the method 200 may be operable to apply the mathematical model in an iterative manner, whilst monitoring a state of growth of the seeds (G(t)) as a real-time input to the mathematical model. More optionally, the method 200 may be operable to apply the mathematical model in an iterative manner, whilst monitoring a state of mould growth of the seeds (M(t)) as a real-time input to the model.

In an embodiment, the method 200 may be operable to blend supplementary materials (such as the supplementary material 122) into the corresponding livestock feed, wherein the supplementary materials include at least one of: hay, wild flower supplements, aromatic supplements, vitamin supplements, growth supplements, antibiotics.

In another embodiment, the method 200 may be operable to employ a gaseous fumigation arrangement (such as the fumigation arrangement 126) for gaseously fumigating the supplied seeds prior to germination to reduce an occurrence of mould growth therein during germination and growing of the seeds to form roots and shoots. More optionally, method 200 may be operable to employ the gaseous fumigation arrangement to utilize ozone gas for fumigating the supplied grain to reduce growth of mould in the plant growth material.

Alternatively, in an embodiment, the method 200 may be operable to provide the ozone gas for fumigation in a concentration in a range of 20 to 40 p.p.m. for a period in a range of 5 minutes to 1 hours. For example, method 200 may be operable to provide the ozone gas for fumigation temporally periodically for fumigating the supplied grain in response to detection of mould formation upon the supplied seeds, their roots and/or their shoots. Further, the one of more hydroponics trays may have a length-to-width ratio in a range of 3:1 to 10:1. Further, the one or more trays are provided with an actuation arrangement for selectively flexing regions of the one or more hydroponics trays for sweeping ponding of nutrient solution occurring therein along a length of the one or more hydroponics trays. Moreover, the one or more trays are disposed in operation on a carousel for at least one of: applying seeds to the one or more trays for growing the plant growth material on the one or more trays, harvesting the plant growth material from the one or more trays.

In an embodiment, the method 200 may be operable to arrange for the one or more hydroponics trays to be disposed in one or more vertical stacks, wherein planes of the one or more hydroponics trays for receiving the seeds are substantially mutually parallel.

In another embodiment, the method 200 may include an arrangement for receiving waste (such as the arrangement for receiving waste 130) from the animals, and for anaerobically digesting the waste to generate methane gas (such as the biogas 134). Alternatively, the present disclosure provides a computer program product comprising a non-transitory computer-readable storage medium having computer-readable instructions stored thereon, the computer-readable instructions being executable by a computerized device comprising processing hardware to execute the method 200 operating a livestock feed production apparatus 100 for generating feed 102 for livestock.

Embodiments of apparatus 100 is advantageous in terms of using highly efficient technology for producing fibrous livestock feed for livestock in a manner that is more efficient than conventional known farming techniques, and provides feed that is more enjoyable and nutritious for livestock to consume.

Additionally, the apparatus 100 is advantageous in terms that it is a better technique of farming which provides better quality and yield of the crop than traditional farming by utilizing lesser resources like water, nutrients, and so forth. Furthermore, the method 200 of the present disclosure is advantageous in terms of a shorter time duration of the grain germination for harvesting plant growth material to produce livestock feed 102. For example, in the method 200 described above grain germination to harvesting cycle ranges between 4 to 8 days. However, in conventional farming harvesting can be done only 2-3 times in a year.

The livestock feed production apparatus (and method) for generating feed for livestock provided in the present disclosure may be configured to (include) maintaining optimum level of CO₂ required for photosynthesis of germinated seeds or fodder. For example, a gas feed arrangement may include one or more sensors for measuring the levels of CO₂ and/or for controlling the release of CO₂, maintaining it a required level or an optimum level of CO₂. The level of CO₂ may be controlled by a gas feed arrangement, or by adjusting parameters, for example changes in temperature of operation which would with speed or slow chemical (or bio-chemical) reactions, including the fodder growth rate.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1-41. (canceled)

42. A livestock feed production apparatus for generating feed for livestock, wherein the livestock feed production arrangement includes:
(i) a seed supply arrangement for supplying seeds;
(ii) a hydroponics arrangement for receiving the supplied seeds and for germinating and growing the supplied seeds in a light-excluded environment in one or more trays to generate plant growth material;
(iii) a harvesting arrangement for receiving the plant growth material and processing the plant growth material to generate the corresponding livestock feed for livestock
(iv) an irrigation arrangement for exposing the supplied seeds to one or more drying steps during growth of the seeds temporally interposed between one or more wet steps during which the seeds are exposed to at least one nutrient solution; and
(v) a data processing arrangement for controlling input of resources into the apparatus by using a mathematical model when growing the supplied seeds, wherein the mathematical model is based upon the measured plant growth characteristics, as a function of physical parameters that influence the measured plant growth characteristics,
wherein the mathematical model is applied in an iterative manner, whilst monitoring a state of growth of the seeds (G(t)) and a state of mould growth of the seeds (M(t)) as a real-time input to the mathematical model.

43. A livestock feed production apparatus of claim 42, wherein the one or more drying steps employing drying conditions that are a function of an evenness of distribution of the seeds within the one or more hydroponics trays, wherein the apparatus includes a seed distribution arrangement for achieving an even distribution of the seeds along and across the one or more trays.

44. A livestock feed production apparatus of claim 42, wherein the apparatus employs (in operable) a nitrogen-enriched air to aerate the growing seeds during the one or more drying steps, wherein the nitrogen-enriched air is employed using an environmental parameter control arrangement and wherein the apparatus controls (in operations) a humidity of the one or more trays when employing the nitrogen-enriched air to aerate the growing seeds during the one or more drying steps.

45. A livestock feed production apparatus of claim 42, wherein the physical parameters that influence the measured plant growth includes one or more of:
(vi) a temporal function of a quantity of water supplied W(t) to the seeds in one or more trays of the apparatus;
(vii) a temporal function of a nutrient solution N(t) supplied to the seeds in the one or more trays;
(viii) a temporal function of temperature (T) of the seeds when growing in the apparatus;
(ix) a function of water cycle employed R(t) when supplying water to the seeds in the apparatus;
(x) a temporal function of ozone exposure O(t) applied to the seeds when in the apparatus;
(xi) a temporal function of lighting applied to the growing seeds (L(t)) when in the apparatus; and
(xii) a planting density (D) employed when applying the seeds to the one or more trays.

46. A livestock feed production apparatus of claim 42, wherein the apparatus (in operations):
blends supplementary materials into the corresponding livestock feed, wherein the supplementary materials include at least one of: hay, wild flower supplements, aromatic supplements, vitamin supplements, growth supplements, antibiotics;
employs a gaseous fumigation arrangement for gaseously fumigating the supplied seeds prior to germination to reduce an occurrence of mould growth therein during germination and growing of the seeds to form roots and shoots;
employs the gaseous fumigation arrangement to utilize ozone gas for fumigating the supplied grain to reduce growth of mould in the plant growth material; and/or
arranges for the one or more hydroponics trays to be disposed in one or more vertical stacks, wherein planes of the one or more hydroponics trays for receiving the seeds are substantially mutually parallel.

47. A livestock feed production apparatus of claim 42, wherein the apparatus (in operation) provides the ozone gas for fumigation in a concentration in a range of 20 to 40 p.p.m. for a period in a range of 5 minutes to 1 hours, wherein the apparatus provides the ozone gas for fumigation temporally periodically for fumigating the supplied grain in response to detection of mould formation upon the supplied seeds, their roots and/or their shoots.

48. A livestock feed production apparatus of claim 42, wherein the one of more hydroponics trays have a length-to-width ratio in a range of 3:1 to 10:1, wherein the one or more trays are provided with an actuation arrangement for selectively flexing regions of the one or more hydroponics trays for sweeping ponding of nutrient solution occurring therein along a length of the one or more hydroponics trays.

49. A livestock feed production apparatus of claim 42, wherein the one or more trays are disposed in operation on a carousel for at least one of: applying seeds to the one or more trays for growing the plant growth material on the one or more trays, harvesting the plant growth material from the one or more trays.

50. A livestock feed production apparatus of claim 42, wherein the livestock feed production apparatus includes an arrangement for receiving waste from the animals, and for anaerobically digesting the waste to generate methane gas.

51. A livestock feed production apparatus of claim 42, wherein the apparatus (in operation) employs off-grid with electricity supplied from at least one of: methane fuel, solar cells, wind turbines, naturally-occurring water flow.

52. A method of operating a livestock feed production apparatus for generating feed for livestock, wherein the livestock feed production arrangement includes:
(i) arranging a seed supply arrangement for supplying seeds;
(ii) arranging a hydroponics arrangement for receiving the supplied seeds and for germinating and growing the supplied seeds in a light-excluded environment in one or more trays to generate plant growth material;
(iii) a harvesting arrangement for receiving the plant growth material and processing the plant growth material to generate the corresponding livestock feed for livestock;
(iv) arranging an irrigation arrangement for exposing the supplied seeds to one or more drying steps during growth of the seeds temporally interposed between one or more wet steps during which the seeds are exposed to at least one nutrient solution; and
(v) arranging a data processing arrangement for controlling input of resources into the apparatus by using a mathematical model when growing the supplied seeds, wherein the mathematical model is based upon the measured plant growth characteristics, as a function of physical parameters that influence the measured plant growth characteristics,
wherein the mathematical model is applied in an iterative manner, whilst monitoring a state of growth of the seeds (G(t)) and a state of mould growth of the seeds (M(t)) as a real-time input to the mathematical model.

53. A method of claim 52, wherein the one or more drying steps employing drying conditions that are a function of an evenness of distribution of the seeds within the one or more hydroponics trays, wherein the method includes a seed distribution arrangement for achieving an even distribution of the seeds along and across the one or more trays.

54. A method of claim 52, wherein the method employs a nitrogen-enriched air to aerate the growing seeds during the one or more drying steps wherein the nitrogen-enriched air is employed using an environmental parameter control arrangement, wherein the method controls a humidity of the one or more trays when employing the nitrogen-enriched air to aerate the growing seeds during the one or more drying steps.

55. A method of claim 52, wherein the physical parameters that influence the measured plant growth includes one or more of:
(vi) a temporal function of a quantity of water supplied W(t) to the seeds in one or more hydroponics trays;
(vii) a temporal function of a nutrient solution N(t) supplied to the seeds in the one or more hydroponics trays;
(viii) a temporal function of temperature (T) of the seeds when growing in the livestock feed production apparatus;
(ix) a function of water cycle employed R(t) when supplying water to the seeds in the livestock feed production apparatus;
(x) a temporal function of ozone exposure O(t) applied to the seeds when in the livestock feed production apparatus;
(xi) a temporal function of lighting applied to the growing seeds (L(t)) when in the livestock feed production apparatus; and
(xii) a planting density (D) employed when applying the seeds to the one or more trays.

56. A method of claim 42, wherein the method (in operation):
blends supplementary materials into the corresponding livestock feed, wherein the supplementary materials include at least one of: hay, wild flower supplements, aromatic supplements, vitamin supplements, growth supplements, antibiotics;
employs a gaseous fumigation arrangement for gaseously fumigating the supplied seeds prior to germination to reduce an occurrence of mould growth therein during germination and growing of the seeds to form roots and shoots;
employs the gaseous fumigation arrangement to utilize ozone gas for fumigating the supplied grain to reduce growth of mould in the plant growth material; and/or
arranges for the one or more hydroponics trays to be disposed in one or more vertical stacks, wherein planes of the one or more hydroponics trays for receiving the seeds are substantially mutually parallel.

57. A method of claim 52, wherein the method (in operations) provides the ozone gas for fumigation in a concentration in a range of 20 to 40 p.p.m. for a period in a range of 5 minutes to 1 hours, wherein the method provides (in operations) the ozone gas for fumigation temporally periodically for fumigating the supplied grain in response to detection of mould formation upon the supplied seeds, their roots and/or their shoots.

58. A method of claim 52, wherein the one of more hydroponics trays have a length-to-width ratio of 3:1 to 10:1, wherein the one or more trays are provided with an actuation arrangement for selectively flexing regions of the one or more hydroponics trays for sweeping ponding of nutrient solution occurring therein along a length of the one or more hydroponics trays.

59. A method of claim 52, wherein the one or more trays are disposed in operation on a carousel for at least one of: applying seeds to the one or more trays for growing the plant growth material on the one or more trays, harvesting the plant growth material from the one or more trays.

60. A method of claim 52, wherein the method includes an arrangement for receiving waste from the animals, and for anaerobically digesting the waste to generate methane gas.

61. A method of claim 52, wherein the method (in operation) employs off-grid with electricity supplied from at least one of: methane fuel, solar cells, wind turbines, naturally-occurring water flow.
